(19) United States
(12) Patent Application Publication
(10) Pub. No.: US 2002/0192428 A1
(43) Pub. Date: Dec. 19, 2002

(54) Method of making vehicle windshield including deletion of coating portion using sandblasting

(76) Inventors: Jean-Marc Sol, Thionville (FR); Alexandre Schalburg, Trier (DE)

Correspondence Address: NIXON & VANDERHYE P.C., 8th Floor, 1100 North Glebe Road, Arlington, VA, 22201, US

(21) Appl. No.: 09/883,488

(22) Filed: Jun. 19, 2001

(51) Int. Cl. B32B 3/10; B32B 17/00

(52) U.S. Cl. 428/138; 156/106; 156/153

(57) ABSTRACT

A method of making a vehicle window (e.g., windshield or backlite), wherein the method includes using sandblasting to delete a portion(s) of a coating (one or more layers) in an area which may require high visible light transmission in the resulting window. After a portion of the coating on a first sheet has been removed or deleted via sandblasting, the first sheet is laminated to another sheet via at least a polymer inclusive interlayer. The interlayer may include PVB in certain embodiments. The step of laminating significantly increases the visible transmission of the resulting vehicle window in the area where sandblasting was used to delete the portion of the coating.

### BACKGROUND OF THE INVENTION

This invention relates to a method of making a vehicle windshield. More particularly, this invention relates to a method of making a vehicle windshield where the method includes sandblasting a portion of a coating (e.g., infrared reflective and/or low-E coating) during a process of manufacture.

In recent years, the use of rain sensors (and/or toll transmitters/receivers) has become commonplace in vehicle windshields. Rain sensors are typically mounted on the interior surface of a the windshield (i.e., on the vehicle interior side of the windshield, or on a rearview mirror mount), and sometimes use infrared (IR) energy/wavelength(s) to detect the presence of water or other liquid (e.g., rain) on the exterior surface of the windshield. Some rain sensors are capable of detecting rain intensity, and thus can determine when to turn on windshield wipers, what speed the wipers should be run at, and/or the like.

Example rain sensors are illustrated and discussed in U.S. Pat. No. 6,232,603, the disclosure of which is hereby incorporated herein by reference. One type of rain sensor includes an IR transmitter which emits IR energy toward the exterior surface of the windshield, and an IR receiver. The IR receiver/detector receives IR energy that is reflected back from the exterior surface of the windshield. The presence of rain or moistures on the exterior surface of the windshield can cause a change in the angle of reflection of the incident IR energy, thereby causing a change in the amount of light being reflected back to the receiver/detector of the rain sensor. In such a manner, the rain sensor can detect the presence of rain or moisture on the exterior surface of a vehicle windshield.

Vehicle windshields typically include first and second glass sheets (bent or flat in shape) laminated to one another via a polymer based interlayer. Unfortunately, many vehicle windshields include an IR reflective coating (e.g., low-E or other type of layer(s) system) located between the glass sheets along with the polymer interlayer. The aforesaid '603 patent explains that the presence of such an IR reflective coating at a location between the rain sensor and the exterior surface of the windshield can be problematic, because it tends to reflect a certain amount(s) of IR energy back to the rain sensor before it reaches the exterior surface of the windshield. Thus, the presence of an IR reflective coating located between the rain sensor and the exterior surface of the windshield is not desirable, as it can cause improper or distorted readings to be made by the rain sensor.

Accordingly, it will appreciated by those skilled in the art that there exists a need for a method of deleting (i.e., removing) a selective portion of a coating (e.g., IR reflective coating), so that an optically sensitive electronic device such as a rain sensor (or toll device) can transmit and/or receive IR energy to/from the exterior surface of a windshield without the presence of the coating directly therebetween. Moreover, the portion of the coating (one or more layers) to be deleted may be located at an interior section of the windshield (as opposed to an edge thereof), which compounds the problem(s) and renders conventional edge deletion techniques non-practical.

Edge deletion of coatings is typically done via chemical treatment such as scouring or the like. However, sandblasting has also been used to edge delete coatings. For example, see U.S. Pat. No. 5,822,107. However, sandblasting tends to roughen the surface underneath the coating portion which is removed, and thus is typically not used in areas which require high amounts of visible light transmission. For example, the coating portion deleted by sandblasting in the '107 patent is located at an edge of the coating wherein overlying opaque silver paste visually hides the area which is sandblasted.

In view of the above, it will be apparent to those skilled in the art that there exists a need in the art for a method of deleting a portion(s) of a coating during the process of making a vehicle window (e.g., windshield or backlite), where the coating portion to be deleted is located in an area of the window requiring high visible light transmission.

### BRIEF SUMMARY OF THE INVENTION

An object of this invention is to provide a method of making a vehicle window (e.g., windshield or backlite), wherein the method includes using sandblasting to delete a portion(s) of a coating (one or more layers) in an area which requires high visible light transmission in the resulting window.

Another object of this invention is to delete a portion(s) of the coating (e.g., IR reflective coating, or any other suitable coating) using sandblasting so as to roughen an underlying surface below the portion of the coating which is deleted, and to thereafter laminate the glass sheet having the sandblasting roughened surface to another glass sheet (curved or flat) via a polymer inclusive interlayer.

Surprisingly, it has been found that the use of the polymer inclusive interlayer (e.g., of or including PVB) during lamination significantly increases the transmission of the sandblast-roughened area. For example, prior to lamination the sandblast-roughened area of the first glass sheet has a visible transmission of from 0-35%, more preferably from 5-25%. However, after the polymer interlayer has been inserted between the first and second glass sheets and the two sheets have been laminated together via the same, the area of the resulting vehicle window including the sandblast-roughened area has a visible transmission of at least 70%, more preferably of at least 75%, and most preferably from 75-90%. Accordingly, it can be seen that without the polymer interlayer, the use of sandblasting would be prohibited in a viewing area of a vehicle window due to the low visible transmission which would result. However, the surprising effect of the polymer interlayer is to significantly increase the visible transmission in the resulting vehicle window at the area where the sandblasting was conducted.

Another object of this invention is to fulfill one or more of the above-listed objects.

Generally speaking, certain example embodiments of this invention fulfill one or more of the above-listed objects by providing a method of making a vehicle window, the method comprising:

providing a first glass sheet which supports a coating;

sandblasting a portion of the coating in order to remove the portion of the coating from being supported by the first glass sheet and create a sandblasted surface roughness area on the first glass sheet at a location where the coating was removed; and

laminating the sandblasted first glass sheet to a second sheet via at least a polymer inclusive interlayer in a manner so as to increase the visible transmission of the first glass sheet at the sandblasted surface roughness area by at least a factor of two so that the resulting vehicle window has a visible transmission of at least 70% at an area where the sandblasting was performed.

Certain other example embodiments of this invention fulfill one or more of the above listed objects by providing a vehicle window comprising:

first and second glass sheets laminated to one another via at least one polymer inclusive interlayer;

a coating for reflecting infrared (IR) energy located on said first glass sheet immediately adjacent said polymer inclusive interlayer; and

a sandblasted area of said first glass sheet is provided at a location where a portion of said coating has been removed from said first glass sheet via sandblasting, so that said polymer inclusive interlayer contacts said sandblasted area of said first glass sheet so that the vehicle window has a visible transmission of at least 70%.

### BRIEF DESCRIPTION OF THE DRAWINGS

FIG. 1 is a front plan view of a vehicle windshield according to an embodiment of this invention.

FIG. 2 is a cross sectional view of the windshield of FIG. 1, taken along Section Line 2-2.

FIG. 3 is a flowchart illustrating steps taken according to a method of making the vehicle window of FIGS. 1-2.

### DETAILED DESCRIPTION OF EXAMPLE EMBODIMENTS OF THIS INVENTION

This invention relates to a method of making a laminated vehicle window (e.g., windshield of backlite). The vehicle window includes a coating (e.g., IR reflecting and/or low-E coating) provided between first and second glass sheets, where the sheet(s) may be curved or flat in different embodiments. Sandblasting is used to delete or remove a portion of the coating from the first glass sheet (prior to lamination) at an area which is to be subsequently used by an optically sensitive electronic device such as a rain sensor, toll device, or radar device (e.g., radar detector, radar transmitter, and/or radar receiver). Because the coating has been removed at this area, the optically sensitive electronic device can transmit and/or receive energy (e.g., IR energy/wavelength(s)) to/from the exterior surface of the window without significant interference from the coating.

After the coating portion has been deleted from the first sheet via sandblasting, the first and second sheets are laminated to one another via a polymer inclusive interlayer. The interlayer may include polyvinyl butyral (PVB), and/or any other suitable material. Surprisingly, it has been found that the use of the polymer inclusive interlayer during lamination significantly increases the transmission of the sandblast-roughened area. For example, prior to lamination the sandblast-roughened area of the first glass sheet may have a visible transmission of from 0-35%, more preferably from 5-25%. However, after the polymer interlayer has been inserted between the first and second glass sheets and the two sheets laminated together, the area of the resulting vehicle window including the sandblast-roughened area has a visible transmission of at least 70%, more preferably of at least 75%, and most preferably from 75-90%. Accordingly, it can be seen that without the polymer interlayer, the use of sandblasting may be counterproductive in a viewing area of a vehicle window due to the low visible transmission which would result. However, the surprising effect of the polymer interlayer is to significantly increase (e.g., by a factor or at least two, and most preferably by a factor of at least three) the visible transmission in the resulting vehicle window at the area where the sandblasting coating deletion was conducted.

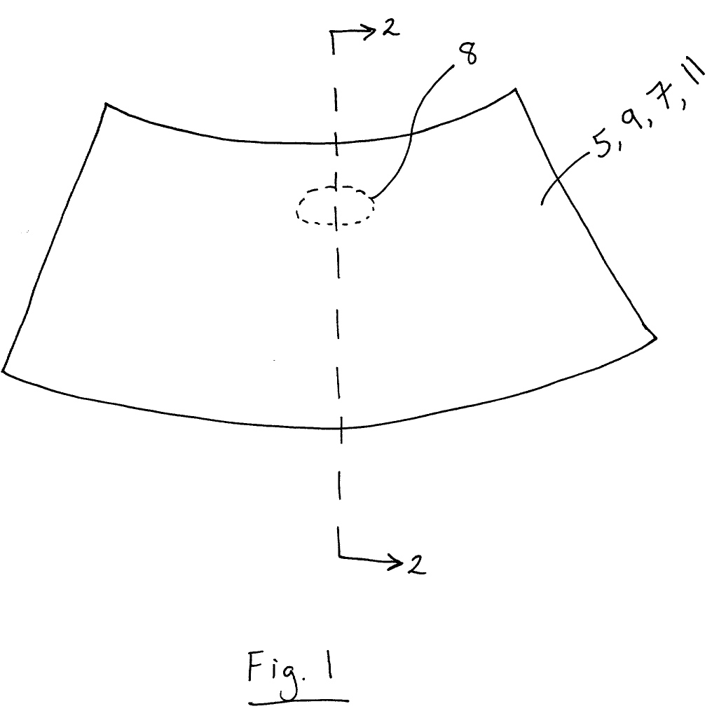

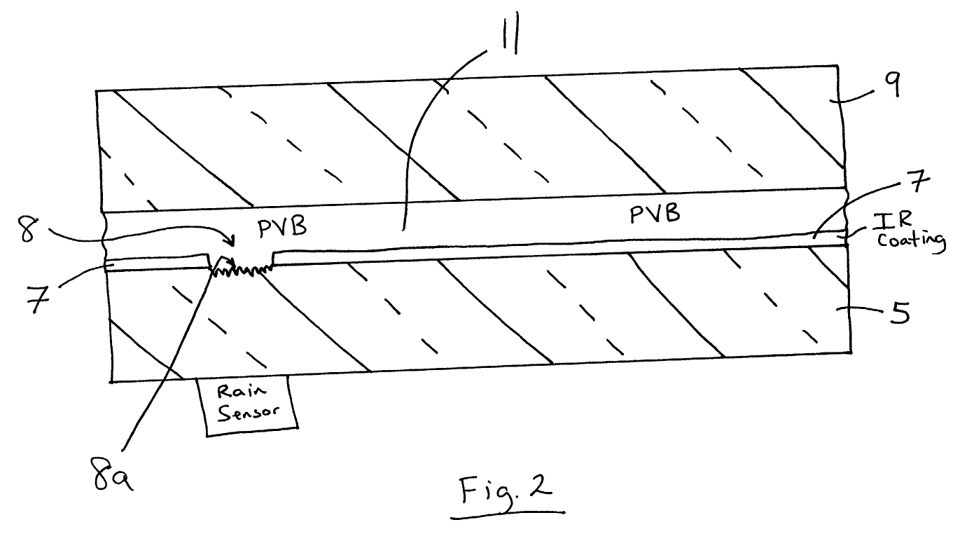

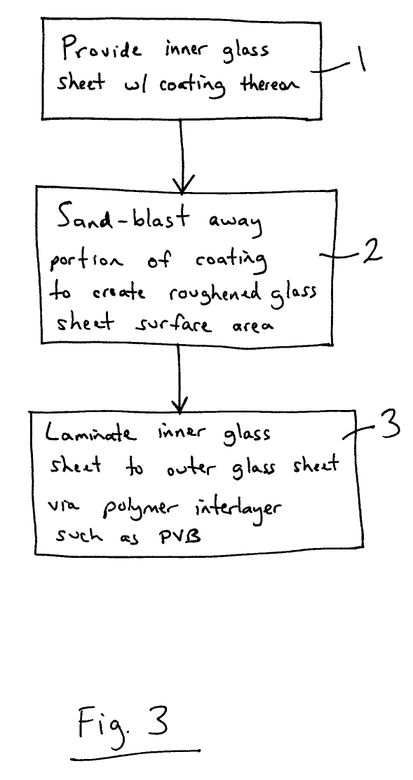

FIG. 1 is a plan view of a vehicle windshield according to an embodiment of this invention. FIG. 2 is a cross sectional view of the windshield of FIG. 1, taken along Section Line 2-2. FIG. 3 is a flowchart illustrating steps taken during the manufacture of the vehicle windshield of FIGS. 1-2.

Referring to FIGS. 1-3, an example process for making the vehicle windshield of FIGS. 1-2 will now be described. Initially, a first glass sheet 5 with a coating 7 thereon is provided (this sheet may ultimately be the interior sheet of the windshield in certain example non-limiting embodiments of this invention) (see step 1 in FIG. 3). Coating 7 may be provided either directly on or indirectly on (i.e., with another layer(s) therebetween) sheet 5 in different embodiments of this invention; in either event the coating 7 is supported by sheet 5. Sheet 5 may be flat or curved in different embodiments of this invention. The coating 7 supported by the first glass sheet 5 may be an IR reflective and/or low-E coating in certain preferred embodiments of this invention. For example, any of the coatings of U.S. Pat. Nos. 5,557,462; 5,800,933; 5,425,861; 5,229,194; 5,514,476; U.S. patent application Ser. No. 09/794,224 (filed Feb. 28, 2001); or U.S. patent application Ser. No. 09/832,335 (filed Apr. 11, 2001) (all of which are hereby incorporated herein by reference) may be used as coating 7 in different embodiments of this invention. Other suitable coatings 7 may also be used in different embodiments of this invention. At this point in the process, coating 7 may be provided across substantially an entire surface of glass sheet 5. Glass sheet 5 may be of soda-lime-silica type glass (e.g., float glass), or other suitable glass, in different embodiments of this invention.

A portion 8 of coating 7 is then removed/deleted from glass sheet 5 via sandblasting (see step 2 in FIG. 3). In certain example embodiments of this invention, the sandblasting may be performed by directing white corundum oxide (i.e., aluminum oxide which may optionally include small amounts of iron, magnesium, silica, etc.) particles at the coating 7 portion to be deleted. In certain example embodiments, the particles may have a mesh size of from 200-400 (e.g., 320) or a particle diameter of from 20-60 μm, more preferably from about 30-50 μm. The particles may be directed at the coating portion to be deleted at any suitable rate (e.g., rate of about 4 meters/minute). The portion 8 of the coating 7 which is deleted may be square, oval, round, rectangular, triangular, or any other suitable shape in different embodiments of this invention. Coating 7 remains on glass sheet 5 in areas not sandblasted (see FIG. 2).

As can be seen in FIG. 2, the sandblasting not only deletes a portion 8 of coating 7, but also creates an area of roughness 8a on an underlying surface of the glass sheet 5 in the area where the coating was deleted. This surface roughness 8a on sheet 5 is caused by particles impinging upon the glass sheet after the coating portion 8 has been removed. According to certain analyses which were conducted on example products made in such a manner, the surface roughness 8a on glass sheet 5 following step 2 in FIG. 3 may be characterized by (1) a roughness average (Ra) of 1.0 to 3.0 μm, more preferably from 1.8 to 2.4 μm; (2) a maximum profile height (Rt) of from 10 to 50 μm, more preferably from 20 to 33 μm; and an average maximum profile height (Rz) of 10 to 25 μm, more preferably from 15 to 22 μm. In this regard, roughness average (Ra) will be understood by those skilled in the art as the area between the roughness profile and its mean line (see ASME B46.1-1995, ASME B46.1-1985, ISO 4287-1997, and ISO 4287/1-1984, all of which are hereby incorporated herein by reference). As for Rt and Rz, also see ASME B46.1-1995 and ISO 4287-1997. The particles used for sandblasting may or may not be recycled during different embodiments of this invention.

After the portion 8 of coating 7 has been deleted by sandblasting in such a manner, the monolithic glass sheet 5 at roughened surface area 8a may have a visible light transmission of no greater than 35%, more preferably from 5-25%, and in certain examples about 15%. As will be explained below, this low visible transmission area will be transformed into a high visible transmission area as a result of lamination.

Second glass sheet 9 is then laminated to sand-blasted glass sheet 5 via at least polymer inclusive interlayer 11 (see step 3 in FIG. 3). Sheet 9 may be flat or curved in different embodiments of this invention. Interlayer 11 may be of or include PVB or any other suitable polymer laminating material in different embodiments of this invention. In order to laminate the two sheets together, PVB layer is first positioned between sheets 5 and 9. Thereafter, the sheets and PVB interlayer 11 are heated in order to perfect the lamination. As can be seen in FIG. 2, after the laminating step interlayer 11 contacts glass sheet 5 at the surface roughness area 8a where coating 7 was deleted and fills in the valleys created by the surface roughness. Interlayer 11 also contacts coating 7 in areas not sandblasted, and may further contact the other glass sheet/substrate 9.

Surprisingly, it has been found that lamination of the two glass sheets 5, 9 to one another via polymer inclusive interlayer 11 causes the visible transmission of the resulting window at sandblasted area 8a to significantly increase from the low value(s) mentioned above to at least 70%, more preferably at least 75%, and most preferably from 75-90%. This enables the window to be used in vehicle windshield applications, and in other applications where the area where the coating portion was deleted is desired to be in a high transmission viewing zone.

FIG. 2 illustrates the use of sandblasting to delete an area of coating 7 which is provided on the interior surface of substrate 5 (i.e., the #3 surface of a windshield). However, this invention is not so limited. Sandblasting may be used, for example, to delete a portion of a coating on an interior surface of substrate 9, on an exterior surface of a substrates, and so forth. Additionally, FIG. 2 illustrates that the entire portion of coating 7 is removed in sandblasted area 8a. Again, this invention is not so limited. In other embodiments, only part of the coating 7 in the sandblasted area need be removed so as to leave a thin portion of the coating on a substrate in the sandblasted area (this may be done when it is necessary to remove part but not all of the coating in a particular area). This may also be done to reduce cycle times in certain embodiments of this invention.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of making a vehicle window, the method comprising:
providing a first glass sheet which supports a coating;
sandblasting a portion of the coating in order to remove the portion of the coating from being supported by the first glass sheet, and create a sandblasted surface roughness area on the first glass sheet at a location where the coating was removed; and
laminating the sandblasted first glass sheet to a second sheet via at least a polymer inclusive interlayer in a manner so as to increase the visible transmission of the first glass sheet at the sandblasted surface roughness area by at least a factor of two so that the resulting vehicle window has a visible transmission of at least 70% at an area where the sandblasting was performed.

2. The method of claim 1, wherein said laminating is performed in a manner so as to increase the visible transmission of the first glass sheet at the sandblasted surface roughness area by at least a factor of three so that the resulting vehicle window has a visible transmission of at least 70% at the area where the sandblasting was performed.

3. The method of claim 2, wherein the second sheet comprises glass, and wherein said laminating is performed in a manner so as to increase the visible transmission of the first glass sheet at the sandblasted surface roughness area by at least a factor of three so that the resulting vehicle window has a visible transmission of at least 75% at the area where the sandblasting was performed.

4. The method of claim 2, wherein the polymer inclusive interlayer comprises polyvinyl butyral (PVB).

5. The method of claim 1, wherein said sandblasting comprises directing particles comprising aluminum oxide toward the portion of the coating.

6. The method of claim 5, wherein the particles comprising aluminum oxide have a mesh size of from 200-400.

7. The method of claim 6, wherein the particles comprising aluminum oxide have a mesh size of about 320.

8. The method of claim 1, wherein said sandblasting comprises directing particles having a mesh size of from 200-400 toward the portion of the coating.

9. The method of claim 1, wherein the coating comprises an infrared (IR) reflecting coating having at least one layer, and wherein the coating is located directly on the first sheet so as to contact the first sheet.

10. The method of claim 1, further comprising mounting a rain sensor proximate an interior side of the vehicle window, so that the rain sensor can send and/or receive infrared (IR) energy to and/or from an exterior surface of the vehicle window through an area where the portion of the coating was removed by said sandblasting.

11. A method of making a vehicle window, the method comprising:
providing a first glass sheet including a coating thereon;
removing only a portion of the coating by sandblasting; and
after said sandblasting, laminating the first glass sheet to a second sheet via at least a polymer inclusive interlayer.

12. The method of claim 11, wherein a portion of the coating is left on the first glass sheet in an area where said sandblasting was carried out.

13. The method of claim 11, wherein said sandblasting removes the portion of the coating down to the glass sheet and roughens a surface of the glass sheet.

14. A vehicle window comprising:
first and second glass sheets laminated to one another via at least one polymer inclusive interlayer;
a coating for reflecting infrared (IR) energy supported by said first glass sheet and located immediately adjacent said polymer inclusive interlayer; and
a sandblasted area of said first glass sheet provided at a location where a portion of said coating has been removed from said first glass sheet via sandblasting, so that said polymer inclusive interlayer contacts said sandblasted area of said first glass sheet so that the vehicle window has a visible transmission of at least 70%.
